(19) United States
(12) Patent Application Publication
(10) Pub. No.: US 2017/0283070 A1
(43) Pub. Date: Oct. 5, 2017

(54) Seat Back for Vehicle

(71) Applicant: MIRUS Aircraft Seating Ltd., Hingham (GB)

(72) Inventors: Phil Hall, Hingham (GB); Ben McGuire, Hingham (GB)

(73) Assignee: MIRUS Aircraft Seating Ltd., Hingham (GB)

(21) Appl. No.: 15/469,013

(22) Filed: Mar. 24, 2017

(30) Foreign Application Priority Data
Apr. 1, 2016 (GB) 1605554.3

(51) Int. Cl. B64D 11/06; A47C 31/00; B60N 2/64

(52) U.S. Cl. CPC B64D 11/0647; B60N 2/64; A47C 31/001

(57) ABSTRACT

A seat back assembly for a vehicle such as an automobile or an aircraft includes a foam support structure. The foam support structure panel is configured to provide a support structure against which the upper body and/or back of a user rests in use. The foam structure may include two or more regions having different foam density and/or firmness.

### BACKGROUND OF THE INVENTION

This invention relates in general to a seat back assembly. In particular, the present invention relates to a seat back or seat back assembly for a vehicle, such as an aircraft.

Seat backs or seat back assemblies for providing support to a seat occupant are well known. The provision of suitable support, as well as softness, to various regions of the back is important to limit the likelihood of harm or discomfort to a seat occupant.

There are certain qualities that are desirable for a seat back assembly intended to form a part of a seat, in particular a vehicle seat, to possess. For example, a seat back assembly will ideally provide both comfort and support to a person occupying the seat. Comfort is a particularly relevant factor for a vehicle seat, such as an aircraft seat, that may be occupied by a person for a significant duration of time. Known aircraft seats, for example, provide a seat back assembly having a rigid support frame at least partially covered with a cushioning layer of fabric. The rigid support frame, which must provide significant structural support to seat occupant in use, may be anchored in position, e.g., by connecting to the base of the seat and/or the floor of the vehicle. The disadvantage of known seat back configurations is that they are usually relatively heavy, which is particularly undesirable in a vehicle such as an aircraft.

Seating systems intended for use in aircrafts preferably possess other qualities or characteristics that are particularly appropriate for the aircraft environment. For example, they may preferably exhibit a high degree of energy absorption for impact resistance and may also have the ability to float in water. Additionally, aircraft seats may incorporate fire retardant features or properties to reduce the spread of a potential fire. A seat back assembly intended for use as part of an aircraft seating system must pass rigorous safety tests to ensure that it is sufficiently strong and/or robust to withstand not just heavy duty use, but also potentially extreme conditions such as may arise in the event of the aircraft impacting with another object.

Furthermore, in the case of air travel, the airplane typically flies with the nose of the aircraft tilted upwardly. As a result, the weight of a seat occupant's body tends to be transferred to the lower back, potentially leading to, or antagonizing, back injury or pain. Thus, the need for seat back assemblies to provide an appropriate support surface arises.

Although numerous seat back designs are known, there is still a need to improve the previously proposed designs, in particular to provide a seat back assembly for a vehicle seat that is more lightweight and yet is sufficiently robust to be suitable, in particular, for an aircraft seating assembly.

### SUMMARY OF THE INVENTION

Embodiments of the present invention seek to provide an improved seat back for a vehicle seat, in particular for an aircraft seating system.

According to a first aspect of the present invention, there is provided a seat back assembly including a first support structure, the first support structure being made of foam and being configured to provide a support structure against which the upper body and/or back of a user rests in use.

According to a second aspect of the present invention, there is provided a seat back structure including a rigid foam material shaped to provide a support surface against which the upper body and/or back of a user rests in use.

Thus, according to embodiments of the present invention, which include a first foam support structure for providing structural support to the seat back assembly, the structural support required for a seat back assembly is at least partially provided by the first foam support structure. As a result, the overall weight of the seat back assembly is significantly reduced as compared to previously proposed designs, wherein all of the structural support is provided by a support frame. Thus, the first foam support structure preferably exhibits sufficient rigidity to be self-supporting when configured and/or disposed to form a seat back assembly of a vehicle seat, and to support the weight of a user in use.

It will be appreciated that different foams have different densities and varying degrees of firmness, shape-memory, and rigidity. A further advantage of using a foam material to form the first structure against which a seat occupant will lean or rest in use is that the properties of the foam, e.g., the density and/or the surface firmness of compressibility, can be selected according to the required performance of the seating assembly in terms of firmness (i.e., how the foam yields to weight and pressure) and/or rigidity and/or viscosity and/or shape memory. Both density and firmness are important indicators of foam performance in relation to comfort, support, and durability. Different foam materials exhibit different molded densities and also provide different degrees of firmness, or compressibility, to a user. It is important to appreciate that foam surface firmness is a value that is independent of foam density. The density refers to the weight of the foam in kg/cubic meter. Thus, the foam material is preferably selected to provide a back support having appropriate support and softness. An example of a suitable material for the first foam structure is expanded polypropylene. Expanded polypropylene foam is available in a range of densities. Preferred embodiments of the present invention utilize expanded polypropylene foam having a density of between 30 g/liter and 65 g/liter. Particularly preferred embodiments of the present invention utilize expanded polypropylene foam having a density of between 45 g/liter and 60 g/liter. Preferably, the firmness of the first, foam structure is greater than 200 N.

A further advantage of embodiments of the present invention arises as a result of the foam support structure being capable of being molded to a particular shape. Thus, according to preferred embodiments, the first foam structure is shaped during manufacture allowing the surface geometry of the foam structure to be manipulated to offer enhanced support and/or comfort. This enables the surface geometry to be selected according to a particular customer's requirements.

Thus, the seat back assembly provides a support surface provided by the first foam structure that is adapted/configured to receive a user. Preferably, the foam support structure is ergonomically shaped and/or sized and/or configured to provide a support surface upon which a user may lean when sitting in a seat including the seat back assembly. Embodiments of the present invention advantageously provide a lightweight seat-back assembly that is customizable, easy to manufacture, and relatively inexpensive.

According to one embodiment, the seat back assembly further includes a second support structure. The second support structure may include a rigid frame. The frame may be formed of a rigid plastic, metal, or composite material. The seat back assembly may further include a rigid back panel that forms a cover such that the frame may be disposed between the foam support structure and the rigid panel.

The rigid panel may form a rear surface of the seat back assembly in use and may, for example, be conveniently formed of molded plastic.

The foam support structure may be, for example, mechanically connected to a seat base and or to a second support structure, such as a frame structure and/or to a back panel or cover by a variety of means, including, e.g., inter-engaging means, bolts, or hook and loop material. Embodiments of the present invention are also envisaged in which a second support structure is partially or completely encapsulated within the first foam support structure. This arrangement is particularly advantageous because it adds additional strength and/or structure to the foam structure, but allows the seat back assembly to be distributed and sold as a single element. The encapsulated support structure may protrude from the body of the foam support structure to facilitate connection to, e.g., a seat base or the vehicle floor.

According to one embodiment, the molded density of the foam structure varies between different regions of the structure. Thus, according to one embodiment, the foam structure includes first and second regions, the first region including a molded density that is higher than the molded density of the second region. Thus, for example, the first region may be provided at a position corresponding to the lower back of an occupant in use, while the second region may be provided at a position corresponding to the upper back of an occupant in use. One or more properties of the foam in the first and second region may appropriately selected depending on the particular requirements of a seating assembly incorporating the foam structure in use. For example, the first region, which may includes the majority of the seat back assembly, may be formed from foam selected to provide a relatively high degree of support to the occupant, while the properties of the foam in the second region, which may be a smaller region provided, e.g., in the lumbar region of the seat, may be selected so as to provide a greater surface compression.

Alternatively, the molded density of the foam structure may be substantially the same throughout the foam structure.

The thickness of the first support structure may also vary between the first and second regions and/or between third and fourth regions (i.e., thickness variations may correlate with density variation or may vary independently). Thus, the first region that is provided at a position corresponding to the lower back of an occupant in use may have a thickness that is greater than the thickness of the foam structure at a position corresponding to the upper back of an occupant in use so as to provide better support in the lumbar region.

According to one embodiment, the foam structure includes first and second regions, wherein the molded density of the first region is different from the molded density of the second region. Additionally, or alternatively, the foam structure includes third and fourth regions, wherein the surface compressibility of the third region is different from the surface compressibility of the fourth region. Preferably, the first and second regions and/or the third and fourth regions are integrally formed.

According to one embodiment of the present invention, the foam structure is shaped to provide a support surface for a seat occupant in use. As a consequence of forming the first support structure from a foam material that is readily moldable, it is possible to shape the panel so as to generally conform to a contour of an occupant's upper body and/or back. Thus, the thickness and/or geometry of the foam support structure can be selected so as to generally conform to the contour of an occupant's back.

According to a preferred embodiment, the foam structure may include a headrest region. Additionally, or alternatively, the foam structure exhibits fire resistive properties. Thus, the foam material itself may exhibit inherent fire resistive properties, and/or may be treated to exhibit fire resistive properties and/or may be covered in a fire resistive fabric.

Preferably, fire-retardant material is provided so as to substantially extend around the outer surface of the foam structure, thereby providing enhanced fire-protection properties. The fire retardant material may, for example, include a fire-block fabric.

The seat back assembly may further includes a cover, or trim, that may be selected for aesthetic reasons and may be any material, such as, e.g., leather or a synthetic material. The cover extends around at least a part of the outer surface of the foam structure.

According to a third aspect of the present invention, there is provided a method of manufacturing a seat back assembly including forming a first support structure from a foam material, wherein the foam material is manipulated so as to have a selected shape and/or geometry.

The method may further include securing the first foam structure relative to a second support structure such that the foam structure is arranged to provide a support surface against which the upper body and/or back of a user rests in use.

According to one embodiment, the step of forming a foam structure includes forming two or more regions having different foam densities and/or firmnesses. This may be achieved, for example, by compressing the foam mixture prior to curing to reduce the volume of the foam mixture, and thus increasing the density, in a particular region.

The method preferably involves molding the foam structure to have a desired shape and/or geometry. This may be achieved by manipulating the foam material when fluid or by utilizing a suitable shaped container, or mold, in which the foam will set/cure. The foam structure may include in-mold features that are added as part of the manufacturing/molding process.

According to a fourth aspect of the present invention, there is provided a seat having a seat back assembly according to the first aspect.

According to a fifth aspect of the present invention, there is provided a vehicle, vessel and/or aircraft having a seat according to the fourth aspect.

Features of any given aspect may be combined with the features of any other aspect, and the various features described herein may be implemented in any combination in a given embodiment.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an exploded perspective view showing a schematic illustration of a seat back assembly according to an exemplary embodiment of the present invention.

FIG. 2 is an enlarged cross-sectional view showing a portion of a seat back assembly according to a second exemplary embodiment.

FIG. 3a is a perspective view showing a row of aircraft seats each including a cushion assembly according to another exemplary embodiment of the present invention.

FIG. 3b is a series of perspective views schematically showing the manner of assembly of one of the cushion assemblies shown in FIG. 3a.

FIG. 4a is a front elevational view of a seat back including a foam structure according to a further exemplary embodiment.

FIG. 4b is a side elevational view of the seat back illustrated in FIG. 4a.

FIG. 4c is a sectional elevational view of the seat back illustrated in FIG. 4a taken along line A-A.

FIG. 4d is a rear perspective view of the seat back illustrated in FIG. 4a.

FIG. 4e is a front perspective view of the seat back illustrated in FIG. 4a.

### DETAILED DESCRIPTION OF THE PREFERRED EMBODIMENTS

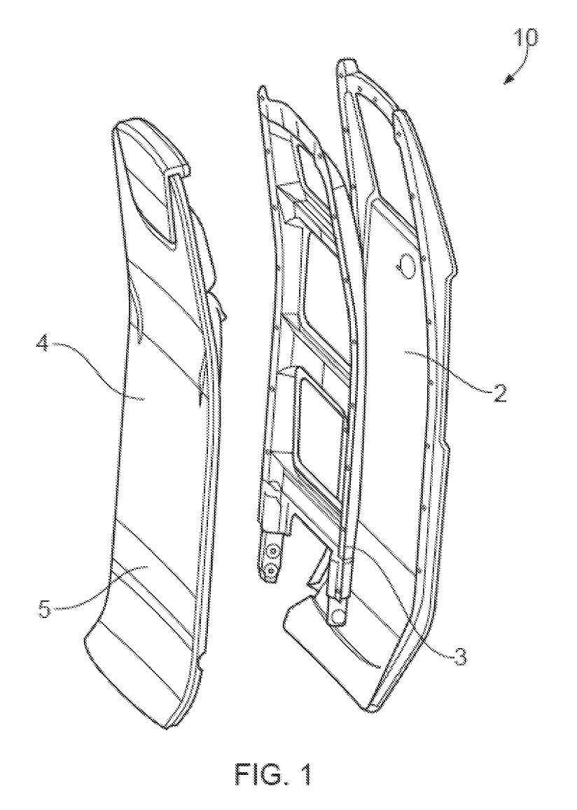

FIG. 1 shows a schematic illustration of a seat back assembly, generally designated 10 according to an embodiment of the present invention. The seat back assembly 10 includes a rigid back panel 2, a support frame 3, and a foam support structure 4. The support frame 3 forms a second support structure of the seat back assembly 10. An engagement mechanism (not shown) is provided to allow the foam support structure 4 to be connected to the support frame 3. For example, the engagement mechanism may include inter-engaging elements respectively located on the foam support structure 4 and the support frame 3. An engagement mechanism (not shown) is also provided to allow the rigid back panel 2 to be connected to the foam support structure 4 and/or the support frame 3.

In this example, the rigid back panel 2 includes molded plastic and forms a rear surface of “shell” of the seat back assembly 10. The support frame 3 may be made of any suitable metal, plastic, or composite material. The foam support structure 4 is formed of expanded polypropylene having a density of around 55 g/liter.

In this particular example, and in order to provide superior lumbar support in the region corresponding to the lower back of an occupant in use, the foam support structure 4 includes a first region 5 that exhibits a foam density and a firmness value that is greater than the foam density and the firmness values associated with the rest of the panel.

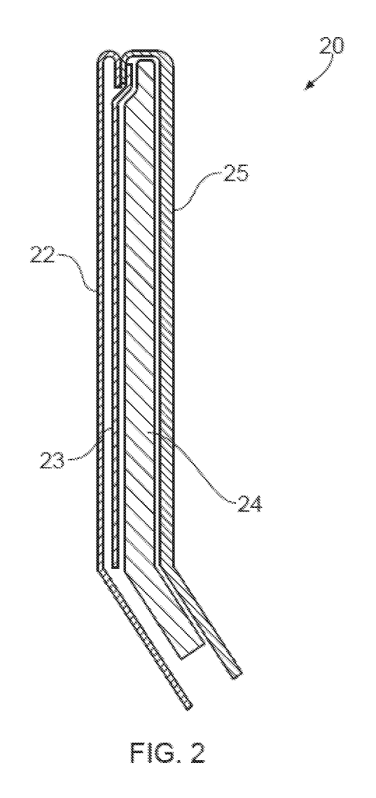

FIG. 2 shows a cross-sectional view of a seat back assembly, generally designated 20, according to a second example embodiment. The seat back assembly 20 includes a rigid back panel 22, a support frame 23, and a foam structure 24. The support frame 23 forms a second support structure of the present invention. In this example, the seat assembly is further provided with a cover 25 that extends over the support surface of the seat back assembly 20 and is folded at a top portion thereof and secured to the rigid support back panel 22. Thus, the foam structure 24 is effectively secured in place relative to the support frame 23, which forms a component of the rigid support structure in this embodiment, by the cover 25.

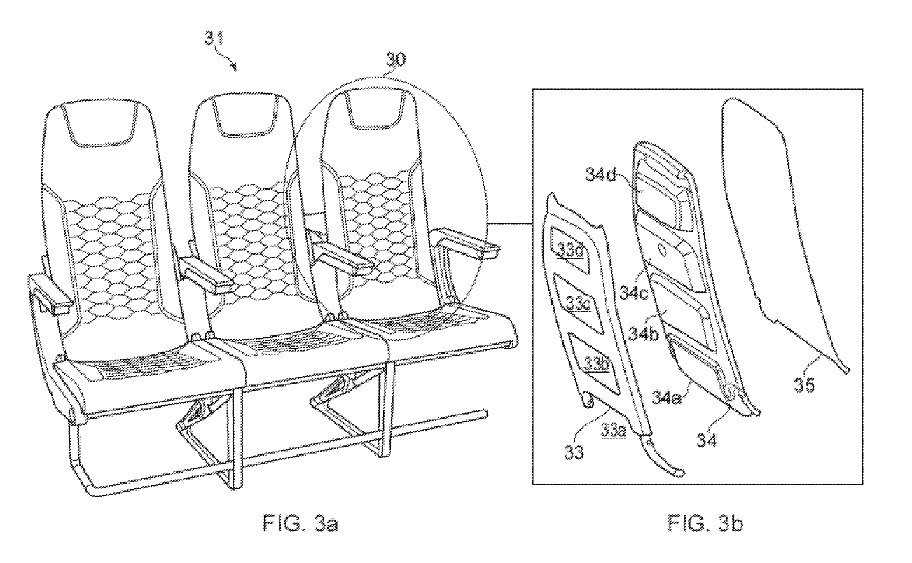

FIG. 3a shows a row of aircraft seats 31 each including a seat back assembly 30 according to another example embodiment of the present invention. A schematic view of the seat back assembly 30 is shown in FIG. 3b and includes a support frame 33, a foam structure 34, and a cover 35. In this exemplary embodiment, the support frame 33 forms a second support structure of the present invention. The rear surface of the foam structure 34 exhibits a shaped profile including a series of projecting foam elements 34a through 34d. These projecting foam elements 34a through 34d are formed during the molding of the foam structure and serve to cooperate with apertures 33a through 33d provided in the support frame 33 in order to facilitate connection of the foam structure 34 to the support frame 33 and thereby secure the foam structure 34 relative to the support frame 33.

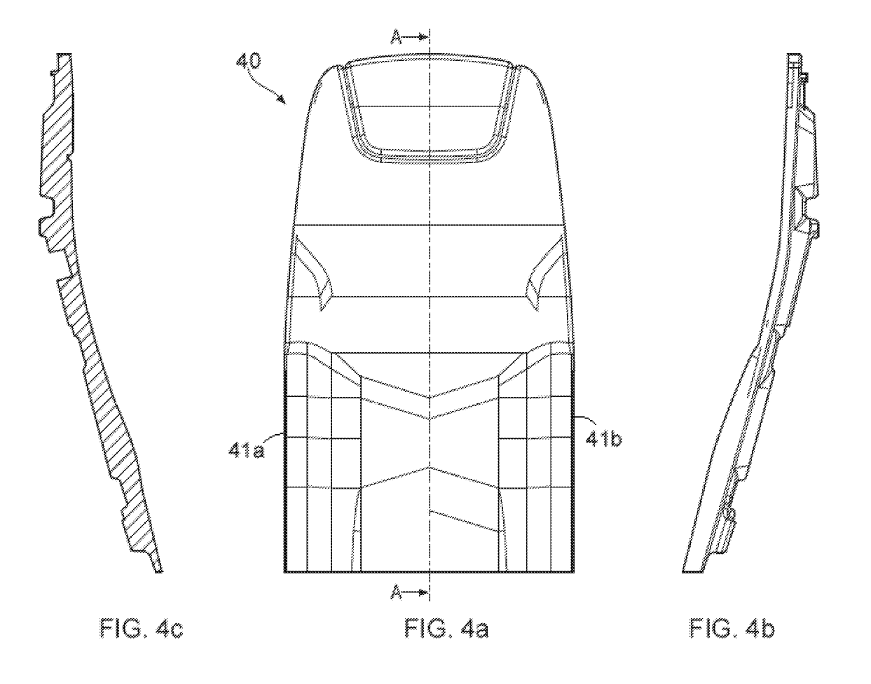

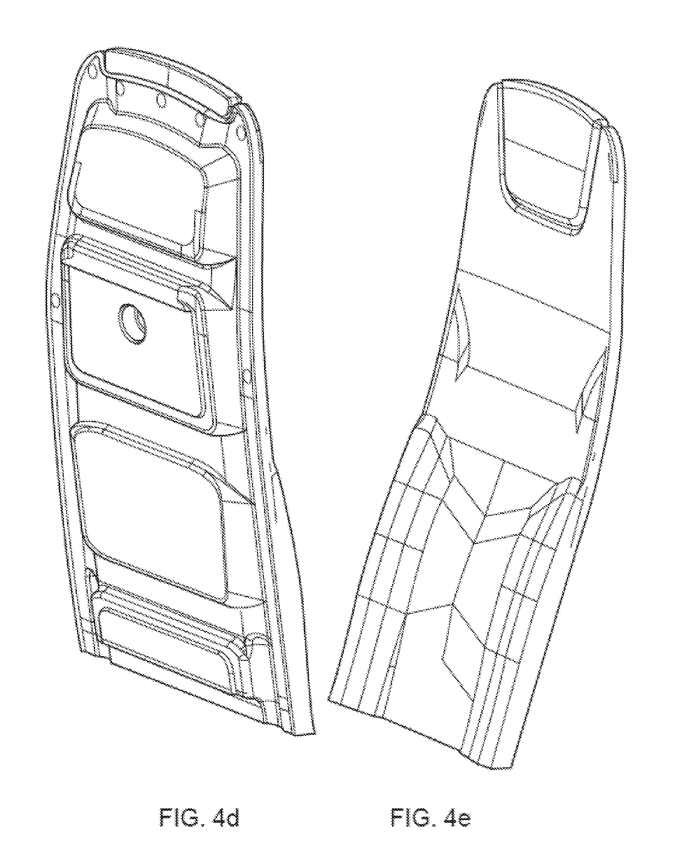

FIGS. 4a though 4e show a further example of a seat back assembly, generally designated at 40, including a foam structure. FIG. 4a shows a front view of the foam structure which exhibits a varied surface geometry as indicated by contour lines. Thus, either side of the center-line A, and in the mid to lower portion of the seat back, the thickness of the foam structure increases towards the lateral side edges (41a and 41b) of the foam structure. This can be seen more clearly in FIG. 4e, which shows an elevational view of the foam structure. FIG. 4b shows a side view of the foam structure and shows a number of surface features that are integrally formed during the molding of the foam structure. FIG. 4c shows a side-view cross-section of the foam structure, while FIG. 4d shows a rear elevation view of the foam structure.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfill the functions of several units recited in the claims. Any reference signs in the claims shall not be construed so as to limit their scope.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A seat back assembly comprising:
a first support structure, the first support structure being made of a foam material and being configured to provide a support structure against which the upper body and/or back of a user rests in use.

2. A seat back assembly as claimed in claim 1, wherein the first support structure includes expanded polypropylene.

3. A seat back assembly as claimed in claim 1, wherein the first support structure has a molded density of between 30 g/liter and 65 g/liter and/or a firmness of at least 200 N.

4. A seat back assembly as claimed in claim 1, wherein the seat back assembly further includes a second support structure.

5. A seat back assembly as claimed in claim 4, wherein the second support structure includes a rigid panel.

6. A seat back assembly as claimed in claim 5, wherein the rigid panel includes molded plastic and/or a frame.

7. A seat back assembly as claimed in claim 6, wherein the frame includes carbon-fiber.

8. A seat back assembly as claimed in claim 1, wherein the first support structure includes first and second regions, and wherein a molded density of the first region is different from a molded density of the second region.

9. A seat back assembly as claimed in claim 1, wherein the first structure includes third and fourth regions, and wherein a surface compressibility of the third region is different from a surface compressibility of the fourth region.

10. A seat back assembly as claimed in claim 9, wherein the first and second regions are integrally formed.

11. A seat back assembly as claimed in claim 9, wherein the third and fourth regions are integrally formed.

12. A seat back assembly as claimed in claim 1, wherein the first support structure exhibits fire resistive properties.

13. A seat back assembly as claimed in claim 1, further including a cover that extends over at least a part of the surface of the first support structure.

14. A seat back assembly as claimed in claim 1, wherein a molded density and thickness of the first region are different from a molded density and thickness of the second region, and wherein the first region is provided at a position corresponding to the lower back of an occupant use, and the second region is provided at a position corresponding to the upper back of an occupant in use.

15. A seat having a seat back assembly according to claim 1.

16. A method of manufacturing a seat back comprising the step of forming a first support structure from a foam material, wherein the foam material is manipulated so as to have a selected shape and/or geometry.

17. A method as claimed in claim 16 further including the step of securing the first support structure relative to a second support structure such that the foam structure is arranged to provide a support structure against which the upper body and/or back of a user rests in use.

18. A method as claimed in claim 16 wherein the step of forming a first structure includes forming two or more regions from a foam material each region having different foam density and/or firmness.
